(19) United States
(12) Patent Application Publication
(10) Pub. No.: US 2004/0250065 A1
(43) Pub. Date: Dec. 9, 2004

(54) Security software code

(76) Inventor: James V. Browning, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/445,161

(22) Filed: May 24, 2003

(51) Int. Cl. H04L 9/00

(52) U.S. Cl. 713/165

(57) ABSTRACT

Installing security software code to a file to perform a first action and/or a second action is disclosed. The first action limits reading of the file to a predetermined rate. The section action renders the file inaccessible after a predetermined length of time. The security software code is thus executed to perform the first action and/or the second action.

### BACKGROUND OF THE INVENTION

Multimedia has become a popular consumer use of computers, and some expect it to largely displace current distribution channels, such as compact discs (CDs) for music and digital versatile discs (DVDs) for movies, in the future. Users download multimedia files, such as music and movie files, to their computers for playback on the computers or on portable player devices. For instance, a user may transfer music files to a portable player device, so that he or she can listen to the music in other locations besides the home. A user may also extract the content from a CD or a DVD, a process known as “ripping,” and save the resulting multimedia files to his or her computer.

Producers and distributors are concerned that such easily distributable multimedia files increase piracy, since users may trade or give away the files without paying for them. A user interested in a particular movie, or a particular artist's songs, may, for example, try to receive such content for free over the Internet, or through a friend, rather than pay for it. As a result, major movie studios and music companies are reticent to set up their own Internet web sites, since users could initially pay to download content and then freely distribute it without remuneration to the company.

### SUMMARY OF THE INVENTION

A method of an embodiment of the invention includes installing security software code to a file to perform at least one of a first action and a second action. The first action limits reading of the file to a predetermined rate. The second action renders the file inaccessible after a predetermined length of time. The security software code is executed to perform at least one of the first action and the second action.

### BRIEF DESCRIPTION OF THE DRAWINGS

FIGS. 1A and 1B are diagrams illustrating two actions that security software code can perform, according to an embodiment of the invention.

FIG. 2 is a flowchart of a method, according to an embodiment of the invention.

FIGS. 3A and 3B are diagrams showing how security software code can be stored on a computer-readable medium relative to a file, such as a data file, according to an embodiment of the invention.

FIGS. 4A, 4B, 5A, and 5B are diagrams illustrating how security software code can render a file inaccessible after a predetermined length of time, according to an embodiment of the invention.

FIGS. 6A, 6B, 7A, and 7B are diagrams illustrating how security software code can limit the rate at which a file can be read, according to an embodiment of the invention.

FIG. 8 is a block diagram of a representative computing device, in accordance with which embodiments of the invention may be implemented.

### DETAILED DESCRIPTION OF THE INVENTION

In the following detailed description of exemplary embodiments of the invention, reference is made to the accompanying drawings that illustrate specific exemplary embodiments in which the invention may be practiced. Other embodiments may be utilized without departing from the spirit or scope of the present invention.

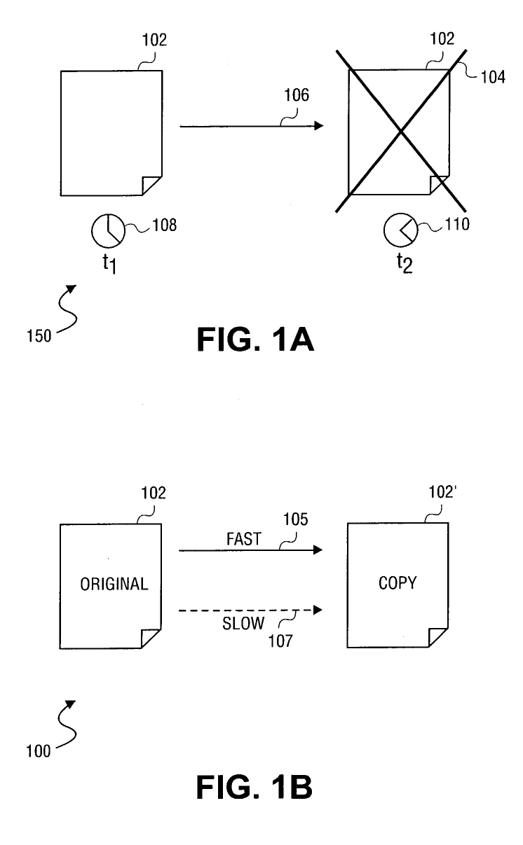

FIGS. 1A and 1B show two different types of actions 100 and 150, respectively, that security software code can perform relative to a file 102, according to an embodiment of the invention. The file 102 can be any type of data file or electronic information, such as a music file, a movie file, or another type of multimedia file.

In FIG. 1A, the action 150 includes rendering the file 102 inaccessible after a predetermined length of time. At time t₁ 108, the file 102 is accessible. However, at a later time t₂ 110, the security software code renders the file 102 inaccessible, as indicated by the X 104. The arrow 106 represents the passage of at least the predetermined length of time. Thus, the security software code provides security by ensuring that the file 102 is not accessible indefinitely, but rather only for a predetermined length of time.

In FIG. 1B, the action 100 includes limiting the rate at which the file 102 can be read to a predetermined rate. The rate at which the file 102 can be played back, in the case of a multimedia file for instance, is limited. Limiting the rate at which the file 102 can be read to a predetermined rate limits the speed or rate at which the file 102 can be copied, as is specifically depicted in FIG. 1B, while not compromising the ability of the user to play back the file as intended. The original file 102 may initially have been copied as the copy of the file 102′ at a fast rate 105. By comparison, the security software code limits the rate at which the file 102 can be copied as the file 102′ at a slow rate 107 that is slower than the fast rate 105. Thus, the security software code provides security by making the process of copying the file 102 time-consuming and inconvenient.

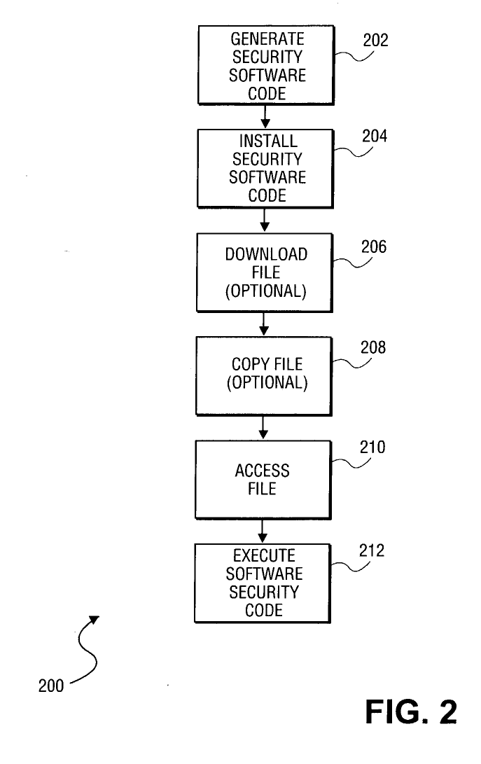

FIG. 2 shows a method 200, according to an embodiment of the invention. The security software code for the file 102 is generated (202) and installed relative to the file 102 (204), as has been described. For example, the security software code may be embedded within the file 102. The security software code implements at least one of the actions 150 and 100 of FIGS. 1A and 1B, respectively. The file 102 may be optionally downloaded (206), and/or copied (208) by the user. Once the file 102 is accessed (210), such as by being read, played back or copied, the security software code (212) is executed to perform either or both of the security actions 150 and 100. The code may be executed currently with the reading or accessing of the file 102.

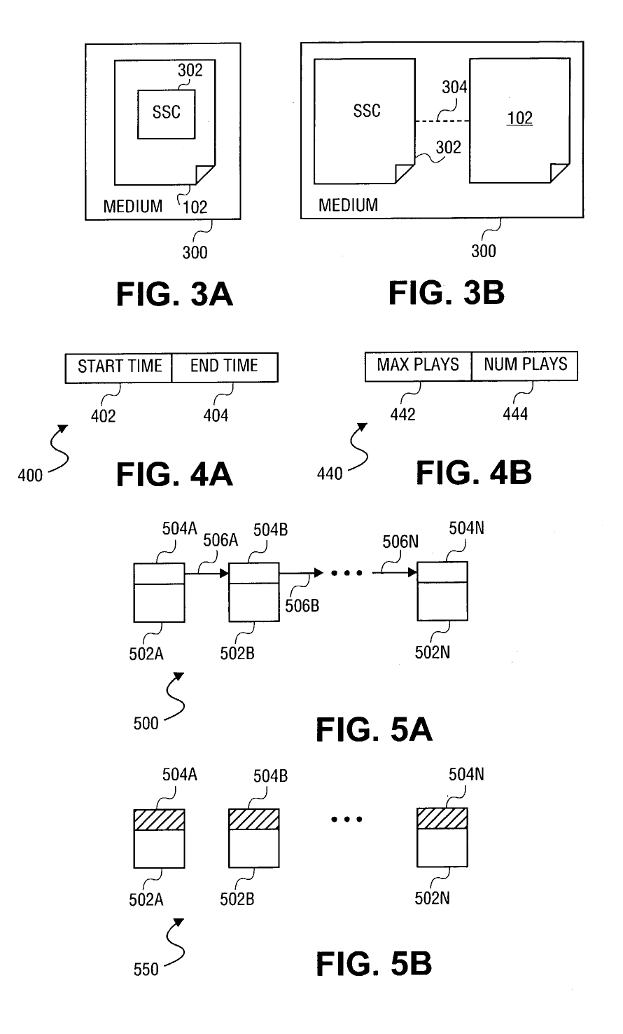

FIGS. 3A and 3B show how security software code 302 can be installed relative to the file 102 on a computer-readable medium 300, according to varying embodiments of the invention. The computer-readable medium 300 may be a part of an article of manufacture, a volatile or a non-volatile medium, a removable or a fixed medium, or a magnetic, optical, and/or solid-state medium, such as a floppy disk, a memory card, a memory permanently or removably internal to a device, or an optical disc.

In FIG. 3A, the security software code 302 has been embedded within the file 102 and stored on the computer-readable medium 300. By comparison, in FIG. 3B, the security software code 302 has been copied to the computer-readable medium 300 to which the file 102 has also been copied or otherwise has been stored. The security software code 302 provides security for the file 102, and thus is related thereto, as indicated in FIG. 3B by the dotted line 304.

The manner by which the file 102 can be rendered inaccessible by security software code 302, according to varying specific embodiments of the invention, is described with reference to FIGS. 4A-4B and 5A-5B. FIGS. 4A and 4B show two different ways 400 and 440 how the security software code 302 can track the predetermined length of time after the file 102 is rendered inaccessible. The security software code 302 may track the predetermined length of time after which the file 102 is rendered inaccessible in other ways as well.

In FIG. 4A, the security software code 302 preferably associates with the file 102 both a start time 402 and an end time 404. The predetermined length of time is thus the difference between the end time 404 and the start time 402. When the current time is past the end time 404, the security software code 302 renders the file 102 inaccessible.

In FIG. 4B, the security software code 302 preferably associates with the file 102 the maximum number of playbacks 442 that are allowed, and also tracks the number of playbacks 444 that have already occurred. When the number of playbacks 444 equals or exceeds the maximum number of playbacks 442 allowed, then the security software code 302 renders the file 102 inaccessible. A playback may be defined as a complete reading or streaming of the file 102, any time the file 102 begins to be read or streamed, regardless of whether the file 102 is completely read or streamed. A playback may also be defined as any type of access of the file 102, or an access in which the user actually listens to or views the file 102.

A specific manner by which the security software code 302 can render the file 102 inaccessible after the predetermined length of time has been exceeded, according to an embodiment of the invention, is described with reference to FIGS. 5A and 5B. In FIG. 5A, the list 500 of file blocks 502A, 502B, . . . , 502N, referred to collectively as the file blocks 502, indicate how the file 102 is stored on a computer-readable medium. Each of the file blocks 502 includes data that is the music, movie, or other type of data represented by the file 102. The file blocks 502, which are typically not contiguous to one another, are stored at different locations on the computer-readable medium.

The file blocks 502A, 502B, . . . , 502N also thus include file headers 504A, 504B, . . . , 504N, collectively referred to as the headers 504, that link the file blocks to successive file blocks. For example, the file block 502A has the file header 506A that links to the file block 502B, the file block 502B has the file header 506B, and a last file header 506N links a file block to the file block 502N. Linking the file blocks to successive file blocks enables the next file block to be located after the current file block has been read, played back, or otherwise accessed.

In FIG. 5B, the software security code 302 has rendered the file 102 unusable by erasing or scrambling the file headers 504 of the file blocks 502. Rendering the file 102 unusable results in a new list of file blocks 550. The rendering of the file headers 504 as unusable is depicted in FIG. 5B by the shading of the file headers 504. Thus, whereas the file blocks 502 still exist, and the data included within the file blocks 502 still exist, the linking of the file blocks 502 as previously accomplished by the file headers 504 no longer exists.

Therefore, a driver, controller, or other type of computer program would not know where to find the file blocks 502 on the computer-readable medium on which they are stored, effectively rendering the file 102 represented by the list of file blocks 502 unusable. The computer program would not know where the file blocks 502 are located on the computer-readable medium on which they are stored. The computer program would also typically not even be able to identify the file blocks 502 from other actual or random data stored on the computer-readable medium, rendering the file 102 effectively unusable.

The security software code 302 can render the file 102 inaccessible or unusable in other ways than that described in conjunction with FIGS. 5A and 5B. For example, the file 102 may itself be erased, such as by erasing the data within the file blocks of the file 102 itself.

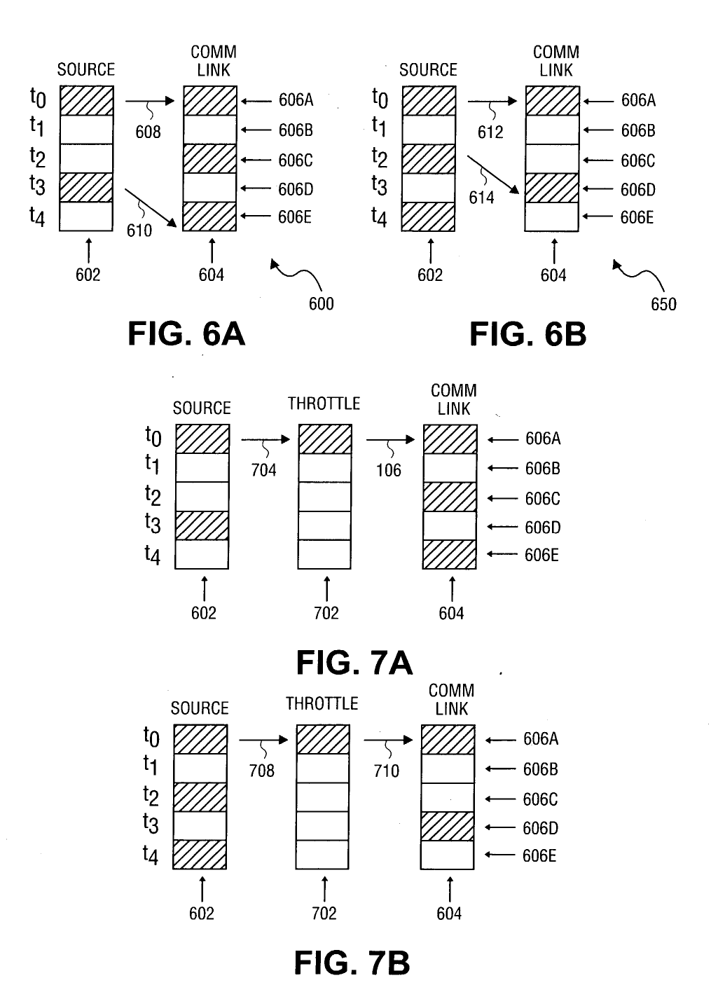

FIGS. 6A, 6B, 7A, and 7B illustrate the manner by which the rate at which the file 102 can be read is limited by the security software code 302, according to an embodiment of the invention. FIGS. 6A and 6B specifically show non-rate-limited access of the file 102. In the diagram 600 of FIG. 6A, a source 602 has a particular access rate, such that data can be retrieved at every third time interval. Thus, for the time intervals 606A, 606B, 606C, 606D, and 606E, representing the time intervals t₁, t₂, t₃, t₄, and t₅, respectively, the file 102 can be accessed from the source 602 at two time intervals, the intervals 606A and 606D, as indicated by shading in FIG. 6A. The source 602 can be, for instance, the computer-readable medium 300 on which the file 102 is stored.

A communications link 604 also has a particular access rate in the diagram 600 of FIG. 6A, such that data can be sent over the link 604 every other time interval. Thus, for the time intervals 606A, 606B, 606C, 606D, and 606E, the file 102 can be sent over the communications link at three time intervals, the intervals 606A, 606C, and 606E, as also indicated by shading in FIG. 6A. The communications link 604 may be, for instance, the manner by which the file 102 is sent to another computing device. For example, where the source 602 and the communications link 604 are part of a portable computing device, such as a portable music player, the communications link 604 may include a serial or other type of cable that connects the computing device to a device such as a desktop computer.

In the diagram 600 of FIG. 6A, the communications link 604 is faster than the source 602. The rate at which the communications link 604 can send data is faster than the rate at which the source 602 can provide data to be sent. Therefore, the data read from the source 602 in the first time interval 606A can be sent over the communications link 604 in this time interval 606A, as indicated by the arrow 608. For the time interval 606C, the communications link 604 will not have received any further data to send. The data read from the source 602 in the time interval 606D can then be sent over the communications link 604 in the time interval 606E, as indicated by the arrow 610.

In FIG. 6B, the diagram 650 shows the reverse scenario where data of the file 102 can be read from the source 602 at a rate that is faster than the rate at which the data can be sent over the communications link 604. The data read from the source 602 in the time interval 606A can again be sent over the communications link 604 in the same time interval 606A, as indicated by the arrow 612. The data read from the source 602 in the time interval 606C is sent over the communications link 604 in the time interval 606D, as indicated by the arrow 614. Finally, the data read from the source 602 in the time interval 606E could not be sent in the first five time intervals 606A, 606B, 606C, 606D, and 606E.

FIGS. 7A and 7B show how the security software code 302 can limit the rate at which the data is read from the file 102, according to an embodiment of the invention. FIG. 7A specifically corresponds to the scenario of FIG. 6A, in which data can be read from the source 602 every third interval, and can be sent over the communications link 604 every other interval. A throttle 702 is inserted between the source 602 and the communications link 604. The predetermined rate of the throttle 702 enables data to be transmitted from the source 602 to the communications link 604 once every five intervals, such as during the interval 606A.

Thus, the data read from the source 602 is sent through the throttle 702, as indicated by the arrow 704, and from the throttle 702 over the communications link 604, as indicated by the arrow 706, within the time interval 606A. Even though further data can be read from the source 602 in the interval 606D, the throttle 702 does not permit the data to be sent over the communications link 604. Similarly, even though further data can be sent over the communications link 604 in the intervals 606C and 606E, the throttle 702 does not permit the data to be transferred from the source 602 to the communications link 604.

FIG. 7B specifically corresponds to the scenario of FIG. 6B, in which data can be read from the source 602 every other interval, and can be sent over the communications link 604 every third interval. The throttle 702 is inserted between the source 602 and the communications link 604. The predetermined rate of the throttle enables data to be transmitted from the source 602 to the communications link 604 once every five intervals, such as during the interval 606A. Thus, the data read from the source 602 is sent through the throttle 702, as indicated by the arrow 708, and from the throttle 702 over the communications link 604, as indicated by the arrow 710, within the time interval 606A.

As before, even though further data can be read from the source 602 in the intervals 606C and 606E, the throttle 702 does not permit the data to be sent over the communications link 604. Similarly, even though further data can be sent over the communications link 604 in the interval 606D, the throttle 702 does not permit the data to be transferred from the source 602 to the communications link 604. Therefore, regardless of whether the original rate at which data can be read from the source 602, the security software code 302, through the throttle 702, is able to limit the rate to a lesser, predetermined rate.

Furthermore, the limiting predetermined rate at which the file 102 can be read as imposed by the security software code 302 is such that playback of the file 102 is not compromised, but high-speed copying of the file 102 is prevented. Having a predetermined rate that is significantly higher than the normal playback speed of the file 102, but significantly lower than the maximum rate at which the file 102, does not impair usability of the file 102, but results in inconveniently long copy times. Preventing high-speed copying by limiting the rate to significantly less than the maximum rate at which the file 102 can be copied therefore acts as a disincentive to piracy.

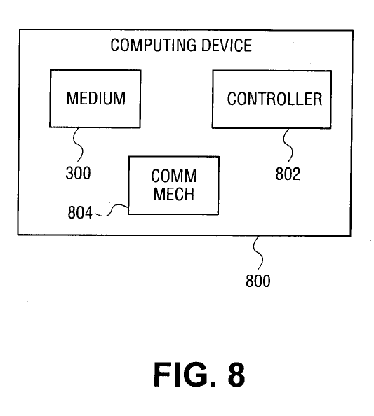

FIG. 8 shows a representative computing device 800. The computing device 800 includes the computer-readable medium 300, a controller 802, and a communications mechanism 804. The medium 300 may be removable or fixed, and volatile or non-volatile. The controller 802 may be implemented in hardware, software, or a combination of hardware and software. The communications mechanism 804 is the manner by which the device 800 sends and receives data, such as the file 102 of FIG. 1, to and from other computing devices. The device 800 may be a general-purpose computer, such as a desktop or laptop computer, a special-purpose device, such as a dedicated music player, or another type of computing device.

The medium 300 is thus receptive to storage of the file 102 that has the security software code 302 related thereto, as has been described. The controller 802 is at least for playback of the file 102, such as reading of the file 102, based on or otherwise in accordance with the security software code 302. The controller 802 may execute the security software code 302, to limit the rate at which the file 102 can be played back to a predetermined rate, and/or to render the file 102 inaccessible after a predetermined length of time, as has been described. The controller 802 may itself add the security software code 302 to the file 102 as or after the file 102 is stored on the medium 300. Alternatively, the file 102 may have already had the code 302 embedded therein prior to storage of the file 102 on the medium 300. As before, the code 302 may be embedded within or external to the file 102.

I claim:

1. A method comprising:
installing security software code to a file to perform at least one of:
a first action comprising limiting reading of a file to a predetermined rate;
a second action comprising rendering the file inaccessible after a predetermined length of time; and
executing the security software code to perform at least one of the first action and the second action.

2. The method of claim 1, wherein installing the security software code to the file comprises embedding the security software code within the file.

3. The method of claim 1, wherein installing the security software code to the file comprises copying the security software code to a computer-readable medium to which the file is also copied.

4. The method of claim 1, wherein limiting the rate at which the file can be read to the predetermined rate comprises limiting the rate at which the file can be read to a rate at which playback is not compromised but at which high-speed copying is prevented.

5. The method of claim 1, wherein rendering the file inaccessible after the predetermined length of time comprises erasing the file after the predetermined length of time.

6. The method of claim 1, wherein rendering the file inaccessible after the predetermined length of time comprises rendering unusable one or more file headers of the file after the predetermined length of time.

7. The method of claim 1, wherein executing the security software code comprises reading the file at no greater than the predetermined rate.

8. The method of claim 1, wherein executing the security software code comprises, upon an access of the file after the predetermined length of time, rendering the file inaccessible.

9. The method of claim 1, further comprising downloading the file.

10. The method of claim 1, further comprising copying the file to a computer-readable medium.

11. The method of claim 1, further comprising generating the security software code.

12. The method of claim 1, further comprising reading the file, such that executing the security software code is performed concurrently with reading of the file.

13. An article of manufacture comprising:
a computer-readable medium;
a data file stored on the medium; and
security software code for the data file and stored on the medium, to limit to limit a reading rate of the data file to a predetermined rate, and to render the data file inaccessible after a predetermined length of time.

14. The article of claim 13, wherein the computer-readable medium is one of: a solid-state medium, an optical medium, and a magnetic medium.

15. The article of claim 13, wherein the security software code is embedded within the data file.

16. The article of claim 13, wherein the security software code is embedded within a file external to the data file.

17. The article of claim 13, wherein the predetermined rate comprises a rate at which playback of the data file is not compromised but at which high-speed copying of the data file is prevented.

18. The article of claim 13, wherein the security software code renders the data file inaccessible by one of erasing the data file after the predetermined length of time and rendering unusable one or more file headers of the data file after the predetermined length of time.

19. The article of claim 13, wherein the data file comprises a multimedia file.

20. The article of claim 13, wherein the data file comprises a multimedia file.

21. A computing device comprising:
a computer-readable medium receptive to storage of a data file having security software code related thereto; and
a controller to playback the data file, and at least one of limit reading of the data file to a predetermined rate and render the data file inaccessible after a predetermined length of time based on the security software code related to the data file.

22. The device of claim 21, wherein the computer-readable medium is removable from the computing device.

23. The device of claim 21, wherein the computer-readable medium is permanently installed within the computing device.

24. The device of claim 21, further comprising a communications mechanism by which the data file is received and stored on the computer-readable medium.

25. The device of claim 24, wherein the controller adds the security software code after the communication mechanism stores the data file on the computer-readable medium.

26. The device of claim 24, wherein the data file already has embedded therein the security software code before the communications mechanism receives the data file and stores the data file on the computer-readable medium.

27. The device of claim 21, wherein the security software code is one of embedded within and external to the data file.

28. The device of claim 21, wherein the predetermined rate comprises a rate at which playback of the data file is not compromised but at which high-speed copying of the data file is prevented.

29. The device of claim 21, wherein the controller renders the data file inaccessible by one of erasing the data file after the predetermined length of time and rendering unusable one or more file headers of the data file after the predetermined length of time.
